(19) United States
(12) Patent Application Publication
(10) Pub. No.: US 2004/0001547 A1
(43) Pub. Date: Jan. 1, 2004

(54) Scalable robust video compression

(76) Inventor: Debargha Mukherjee, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/180,205

(22) Filed: Jun. 26, 2002

(51) Int. Cl. H04N 7/12

(52) U.S. Cl. 375/240.16; 375/240.12; 375/240.14; 375/240.03; 375/240.22

(57) ABSTRACT

A frame in a video sequence is compressed by generating a compressed estimate of the frame; adjusting the estimate by a factor α, where 0<α<1; and computing a residual error between the frame and the adjusted estimate. The residual error may be coded in a robust and scalable manner.

### BACKGROUND

Data compression is used for reducing the cost of storing video images. It is also used for reducing the time of transmitting video images.

The Internet is accessed by devices ranging from small handhelds to powerful workstations over connections ranging from 56 Kbps modems to high-speed Ethernet links. In this environment a rigid compression format producing compressed video image only at a fixed resolution and quality is not always appropriate. A delivery system based on such a rigid format delivers video images satisfactorily to a small subset of the devices. The remaining devices either cannot receive anything at all or receive poor quality and resolution relative to their processing capabilities and the capabilities of their network connections.

Moreover, transmission uncertainties can become critical to quality and resolution. Transmission uncertainties can depend on the type of delivery strategy adopted. For example, packet loss is inherent over Internet and wireless channels. These losses can be disastrous for many compression and communication systems if not designed with robustness in mind. The problem is compounded by the uncertainty involved in the wide variability in network state at the time of the delivery.

It would be highly desirable to have a compression format that is scalable to accommodate a variety of devices, yet also robust with respect to arbitrary losses over networks and channels with widely varying congestion and fading characteristics. However, obtaining scalability and robustness in a single compression format is not trivial.

### SUMMARY

A video frame is compressed by generating a compressed estimate of the frame; adjusting the estimate by a factor α, where 0<α<1; and computing a residual error between the frame and the adjusted estimate. The residual error may be coded in a robust and scalable manner.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a video delivery system according to an embodiment of the present invention.

FIG. 2 is an illustration a two-level subband decomposition for a Y-Cb-Cr color image.

FIG. 3 is an illustration of a coded P-frame.

FIG. 4 is a diagram of a quasi-fixed length encoding scheme.

FIG. 5 is an illustration of a portion of a bitstream including a coded P-frame.

FIGS. 6a and 6b are flowcharts of a first example of scalable video compression according to an embodiment of the present invention.

FIGS. 7a and 7b are flowcharts of a second example of scalable video compression according to an embodiment of the present invention.

FIG. 8 is an illustration of a portion of a bitstream including a coded P-frame and a coded B-frame.

### DETAILED DESCRIPTION

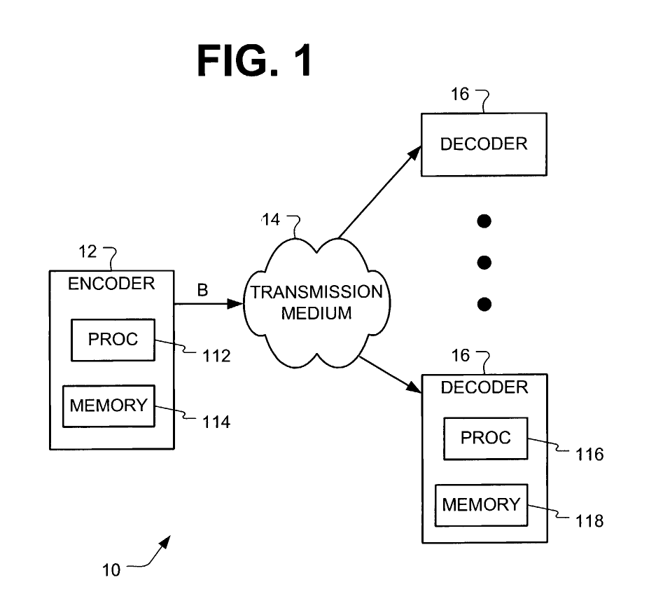

Reference is made to FIG. 1, which shows a video delivery system including an encoder 12, a transmission medium 14, and a plurality of decoders 16. The encoder 12 compresses a sequence of video frames. Each video frame in the sequence is compressed by generating a compressed estimate of the frame, adjusting the estimate by a factor α and computing a residual error between the frame and the adjusted estimate. The encoder 10 may compute the residual error (R) as R=I-αI_{E}, where I_{E} is the estimate and I is the video frame being processed. If motion compensation is used to compute the estimates, the encoder 10 codes the motion vectors and residual error, and adds the coded motion vectors and the coded residual error to a bit stream (B). Then the encoder 10 encodes the next video frame in the sequence.

The bitstream (B) is transmitted to the decoders 16 via the transmission medium 14. A medium such as the Internet or a wireless network can be unreliable Packets can be dropped.

The decoders 16 receive the bitstream (B) via the transmission medium 14, and reconstruct the video frames from the compressed content. Reconstructing a frame includes generating an estimate of the frame from at least one previous frame that has been decoded, adjusting the estimate by the factor α, decoding the residual error, and adding the decoded residual error to the adjusted estimate. Thus each frame is reconstructed from one or more previous frames.

The encoding and decoding will now be described in greater detail. The estimates may be generated in any way. However, compression efficiency can be increased by exploiting the inherent temporal or time based redundancies of the video frames. Most consecutive frames within a sequence of video frames are very similar to the frames both before and after the frame being compressed. Inter-frame prediction exploits this temporal redundancy using a technique known as block-based motion compensated prediction.

The estimates may be Prediction-frames (P-frames). The P-frames may be generated by using, with minor modification, a well-known algorithm such as MPEG 1, 2 and 3 or an algorithm from the H.263 family (H2.61, H2.63, H2.63+ and H2.63L). The algorithm is modified in that motion is determined between blocks in the current frame (I) and blocks in a previously adjusted estimate. A block in the current frame is compared to different blocks in a previous adjusted estimate, and a motion vector is computed for each comparison. The motion vector having the minimum error may be selected as the motion vector for the block.

Multiplying the estimate by the factor α reduces the pixel values in the estimate. The factor 0<α<1 reduces the contribution of the prediction to the coded residual error, and thereby makes the reconstruction less dependent on prediction and more dependent upon the residual error. More energy is pumped into the residual error, which decreases the compression efficiency, but increases robustness to noisy channels. The lower the value of the factor α, the more the resilience to errors, but less efficient in compression. The factor α limits the influence of a reconstructed frame to the next few reconstructed frames. That is, a reconstructed frame is virtually independent of all but several preceding reconstructed frames. Even if there was an error in a preceding reconstructed frame, or some mismatch due to reduced resolution decoding, or even if a decoder 16 has incorrect versions of previously reconstructed frames, the error propagates only for the next few reconstructed frames, becoming weaker eventually and allowing the decoder 16 to get back in synchronization with the encoder.

The factor α is preferably between 0.6 and 0.8. For example, if α=0.75, the effect of the error is down to 10% within eight frames as 0.75⁸=0.1, and is visually imperceptible even earlier. If α=0.65, the effect of the error is down to 7.5% within six frames as 0.65⁶=0.075.

Visually, an error in a P-frame first shows up as an out-of-place mismatch block in the current frame. If α=1, the same error remains in effect over successive frames. The mismatch block may break up into smaller blocks and propagate with motion vectors from frame to frame, but the pixel errors in mismatch regions do not reduce in strength. On the other hand, if α=0.6−0.8 or less, the error keeps reducing in strength from frame to frame, even as they break out into smaller blocks.

The factor α may be adjusted according to transmission reliability. The factor α may be a pre-defined design parameter that both the encoder 12 and the decoder 16 know beforehand. In the alternative, the factor α might be transmitted in a real-time transmission scenario, in which the factor α is included in the bitstream header. The encoder 16 could decide on the fly the value of the factor α based on available bandwidth and current packet loss rates.

The encoder 10 may be implemented in different ways. For example, the encoder 10 may be a machine that has a dedicated processor for performing the encoding; the encoder 10 may be a computer that has a general purpose processor 110 and memory 112 programmed to instruct the processor 110 to perform the encoding; etc.

The decoders 16 may range from small handhelds to powerful workstations. The decoding function may be implemented in different ways. For example, the decoding may be performed by a dedicated processor; a general purpose processor 116 and memory 118 programmed to instruct the processor 110 to perform the decoding, etc a program encoded in memory.

Because a reconstructed frame is virtually independent of all but several preceding reconstructed frames, the residual error can be coded in a scalable manner. The scalable video-compression is useful for streaming video applications that involve decoders 16 with different capabilities. A decoder 16 uses that part of the bitstream that is within its processing bandwidth, and discards the rest. The scalable video-compression is also useful when the video is transmitted over networks that experience a wide range of available bandwidth and data loss characteristics.

Although MPEG and the H.263 algorithms generate I frames, I-frames are not needed for video coding, not even in an initial frame. Decoding can begin at an arbitrary point in the bitstream (B). By using the factor α, the first few decoded P-frames would be erroneous but then within ten frames or so, the decoder 16 becomes synchronized with the encoder 12.

For example, the encoder 12 and decoder 16 can be initialized with all-gray frames. Instead of transmitting an I-frame or other reference frame, the encoder 12 starts encoding from an all-gray frame. Likewise, the decoder 16 starts decoding from an all-gray frame. The all-gray frame can be decided upon by convention. Thus the encoder 12 does not have to transmit an all-gray frame, an I-frame or other reference frame to the decoder 16.

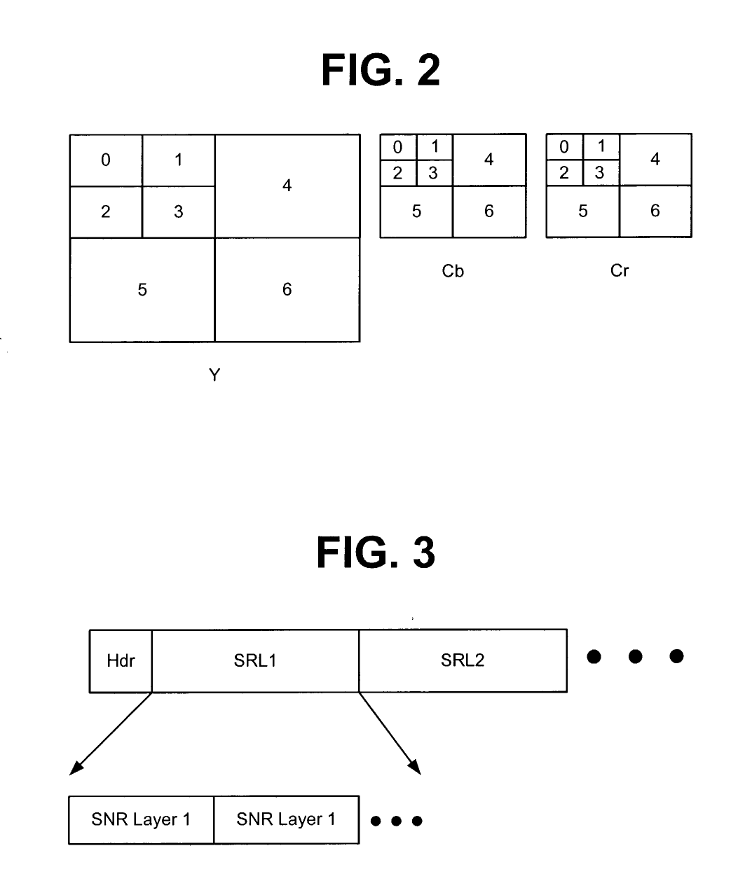

Reference is now made to FIGS. 2-5, which describe the scalable coding in greater detail. Wavelet decomposition leads naturally to spatial scalability, therefore, wavelet encoding of a frame of the residual error is used in lieu of traditional DCT based coding. Consider a color image where each image is decomposed into three components: Y, Cb, Cr, where Y is luminance, Cr is the red color difference, and Cb is the blue color difference. Typically, Cb and Cr are at half the resolution of Y. To encode such a frame, first wavelet decomposition with bi-orthogonal filters is performed. For example, if a two-level decomposition is done, the subbands would appear as shown in FIG. 2. However, any number of decomposition levels may be used.

Coefficients resulting from the subband decomposition are quantized. The quantized coefficients are next scanned and encoded in subband-by-subband order from lowest to highest, yielding spatial resolution layers that yield progressively higher resolution reproductions increasing by an octave per layer. The first (lowest) spatial resolution layer includes information about subband 0 of the Y, Cb, and Cr components. The second spatial resolution layer includes information about subbands 1, 2, and 3 of the Y, Cb and Cr components. The third spatial resolution layer includes information about subbands 4, 5, and 6 of the Y, Cb and Cr components. And so on. The actual coefficient encoding method used during the scan may vary from implementation to implementation.

The coefficients in each spatial resolution layer may be further organized in multiple quality layers or multiple SNR layers. (SNR-scalable compression refers to coding a sequence in such a way that different quality video can be reconstructed by decoding a subset of the encoded bitstream.) Successive refinement quantization using either bit-plane-by-bit-plane coding or multistage vector quantization may be used. In such methods, coefficients are encoded in several passes, and in each pass, a finer refinement to the coefficients belonging to a spatial resolution layer is encoded. For example, coefficients in subband 0 of all three (Y, Cb, and Cr) components are scanned in multiple refinement passes. Each pass produces a different SNR layer. The first spatial resolution layer is finished after the least significant refinement has been encoded. Next all three (Y, Cb, and Cr) components of subbands 1, 2, and 3 of all three are scanned in multiple refinement passes to obtain multiple SNR layers for the second spatial resolution layer.

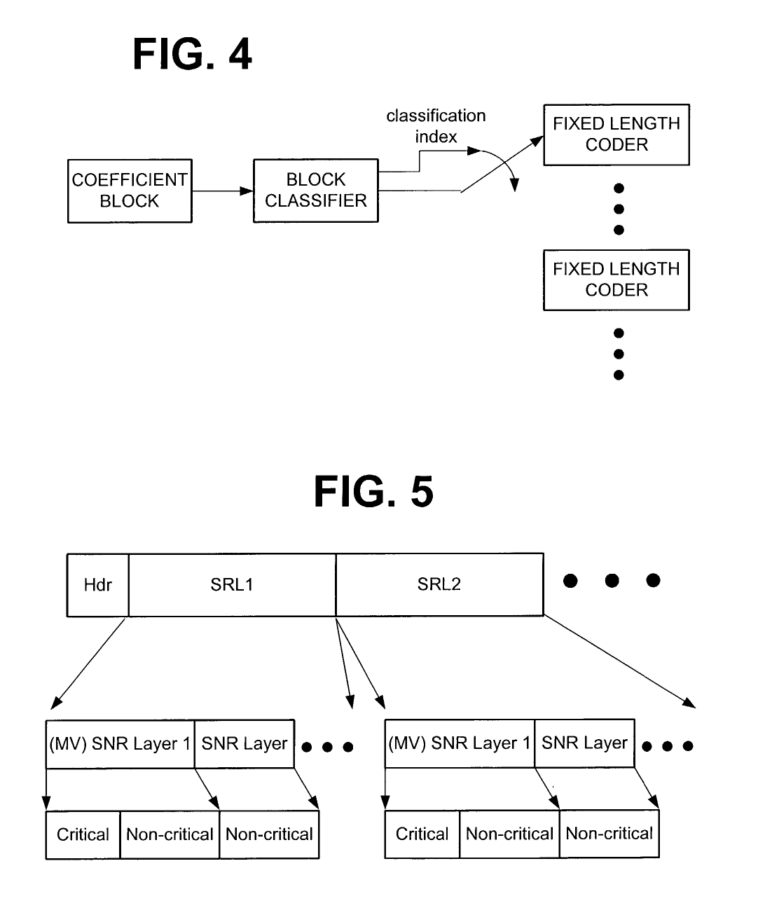

An exemplary bitstream organization for a P-frame is shown in FIG. 3. The first spatial resolution layer (SRL1) follows a header (Hdr), and second spatial resolution layer (SRL2) and subsequent spatial resolution layers follow the first spatial resolution layer (SRL1). Each spatial resolution layer includes multiple SNR layers. Motion vector (MV) information is added to the first SNR layer of the first spatial resolution layer to ensure that the motion vector information is sent at the highest resolution to all decoders 16. In the alternative, a coarse approximation of the motion vectors may be provided in the first spatial resolution layer, with gradual motion vector refinement provided in subsequent spatial resolution layers.

From such a scalable bitstream, different decoders 16 can receive different subsets producing less than full resolution and quality, commensurate with their available bandwidths and their display and processing capabilities. Layers are simply dropped from the bitstream to obtain lower spatial resolution and/or lower quality. A decoder 16 that receives less than all SNR layers but receives all spatial layers can simply use lower quality reconstructions of the residual error frame to reconstruct the video frames. Even though the reference frame at the decoder 16 is different from that at the encoder 12, error doesn't build-up because of the factor α. A decoder 16 that receives less than all of the spatial resolution layers (and perhaps uses less than all of the SNR layers) would use lower resolutions at every stage of the decoding process. Its reference frame is at lower resolution, and the received motion vector data is scaled down appropriately to match it. Depending on the implementation, the decoder 16 may either use sub-pixel motion compensation on its lower resolution reference frame to obtain a lower resolution predicted frame, or it may truncate the precision of the motion vectors for a faster implementation. In the latter case, the error introduced would be more than in the former case and, consequently, reconstructed quality would be poorer, but in either case the factor α ensures that errors decay quickly and do not propagate. The quantized residual error coefficient data is decoded only up to the given resolution, followed by inverse quantization and appropriate levels of inverse transforms, to yield the lower resolution residual error frame. The lower resolution residual error frame is added to the adjusted estimate to yield a lower resolution reconstructed frame. This lower resolution reconstructed frame is subsequently used as a reference frame for reconstructing the next video frame in the sequence.

For the same reasons that the factor α allows top-down scalability to be incorporated, it also allows for greater protection against packet losses over an unreliable transmission medium 14. Still, robustness can be improved by using Error Correction Codes (ECC). However, protecting all coded bits equally can waste bandwidth and/or reduce the robustness in channel mismatch conditions. Channel mismatch occurs when a channel turns out to be worse than what the error protection was designed to withstand. Specifically, channel errors often occur in bursts, but bursts occur only randomly and not very often on an average. Protecting all bits for the worst-case error bursts can waste bandwidth, but protecting for the average case can lead to complete delivery system failure when error bursts occur.

Bandwidth is minimally reduced and robustness is maintained by using unequal protection of critical and non-critical information within each spatial resolution layer. Information is critical if any errors in the information cause catastrophic failure (at least until the encoder 12 and decoder 16 are brought back into synchronization). For example, critical information indicates the length of bits to follow. Information is non-critical if errors result in quality degradation but do not cause catastrophic loss of synchronization.

Critical information is protected heavily to withstand worst-case error bursts. Since critical information forms only a small fraction of the bitstream the bandwidth wastage is significantly reduced. Non-critical bits may be protected with varying levels of protection, depending on how insignificant the impact of errors on these is. During error bursts, which leads to heavy packet loss and/or bit errors, some errors are made in the non-critical information. However, the errors do not cause catastrophic failure. While there is a graceful degradation in quality, whatever degradation is suffered as a result of incorrect coefficient decoding is quickly recovered.

Reducing the amount of critical information reduces the amount of bandwidth wastage yet ensures robustness. The amount of critical information can be reduced by using vector quantization (VQ). Instead of coding one coefficient at a time, several coefficients are grouped together into a vector, and coded together.

Classified Vector Quantization may be used. Each vector is classified into one of several classes, and based on the classification index, one of several fixed length vector quantizers is used.

There are a variety of ways in which the vectors may be classified. Classification may be based on statistics of the vectors that are to be coded, so that the classified vectors are represented efficiently within each class with a few bits. Classifiers may be based on vector norms.

Multi-stage vector quantization (MSVQ) is a well-known VQ technique. Multiple stages of a vector relate to SNR scalability only. The bits used for each stage become parts of a different SNR layer. Each successive stage further refines the reproduction of a vector. A classification index is generated for each vector quantizer. Because different vector quantizers may have different lengths, the classification index is included among the critical information. If an error is made in the classification index, the entire decoding operation from that point on fails (until synchronization is reestablished), because the number of bits used in the actual VQ index that follows would also be in error. The VQ index for each class is non-critical because an error does not propagate beyond the vector.

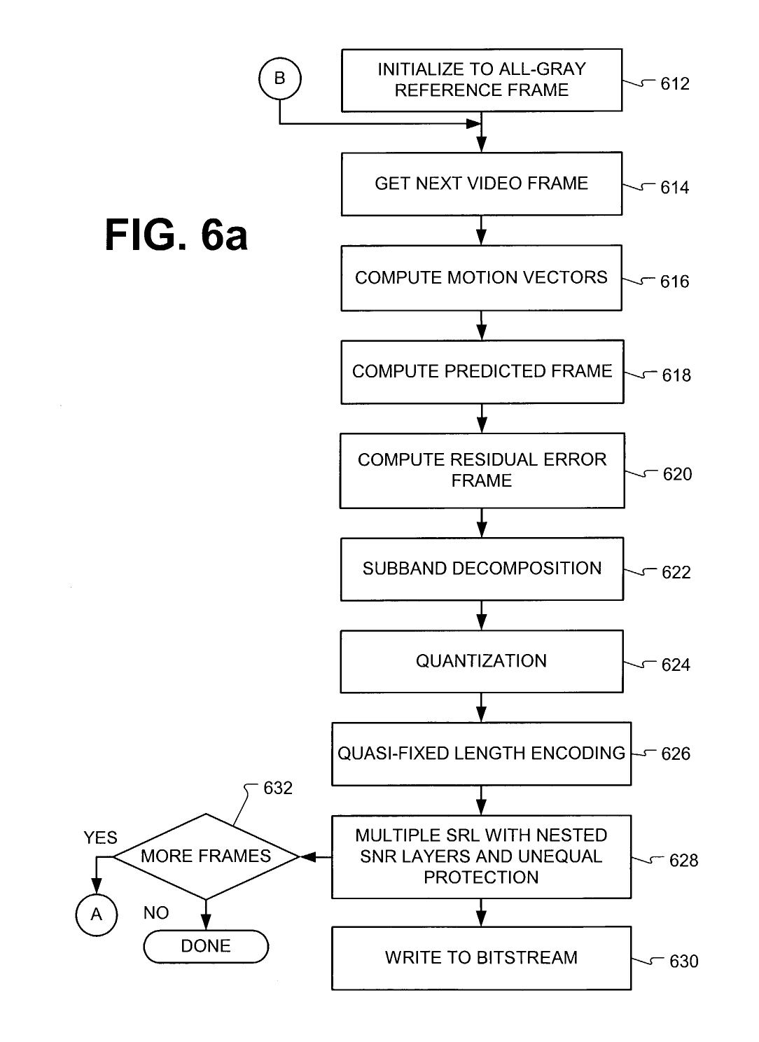

FIG. 4 shows an exemplary strategy for such quasi-fixed length coding. Quantized coefficients in each subband are grouped into small independent blocks of size 2×2 or 4×4, and for each block a few bits are transmitted to convey a classification index (or a composite classification index). For the given classification index, the actual bits used to encode the entire block becomes fixed. The classification index is included among critical information, while fixed length coded bits are included among the non-critical information.

Increasing the size of a vector quantizer allows a greater number of coefficients to be coded together and fewer critical classification bits to be generated. If fewer critical classification bits are generated, then fewer bits need to be protected heavily. Consequently, the bandwidth penalty is reduced.

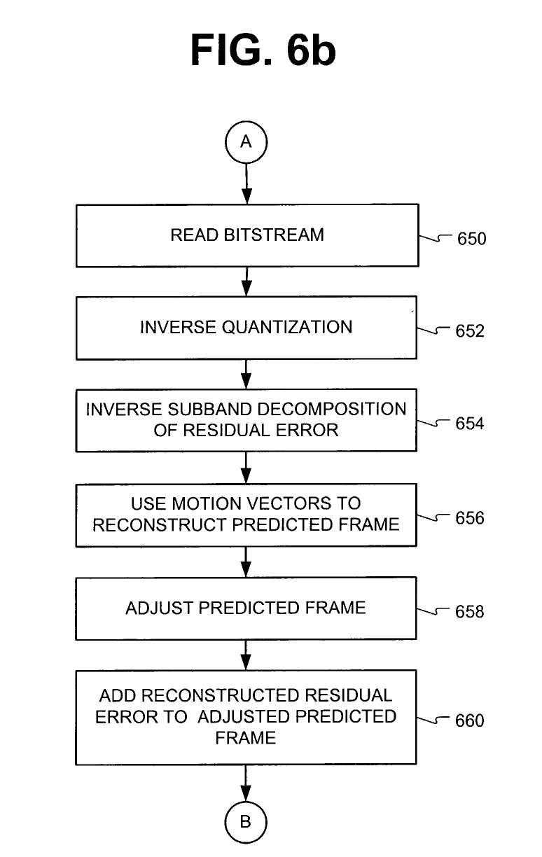

Referring to FIG. 5, the bitstream for each P-frame can be organized such that the first SNR layer in each spatial resolution layer contains all of the critical information. Thus, the first SNR layer in the first spatial resolution layer contains the motion vector and classification data. The first spatial resolution layer also contains the first stage VQ index for the coefficient blocks, but the first stage VQ index is among the non-critical information. The first SNR layer in the second spatial layer contains critical information such as classification data, and non-critical information such as the first stage VQ indices and residual error vectors. In the second and subsequent SNR layers of each spatial resolution, non-critical information further includes refinement data for the residual error vectors.

Critical information may be protected heavily, and the non-critical information may be protected lightly. Furthermore, the protection for both critical and non-critical information can be decreased for higher SNR and/or spatial resolution layers. The protection can be provided by any forward error correction (FEC) scheme such as block codes, convolution codes, or Reed-Solomon codes. The choice of FEC will depend upon the actual implementation.

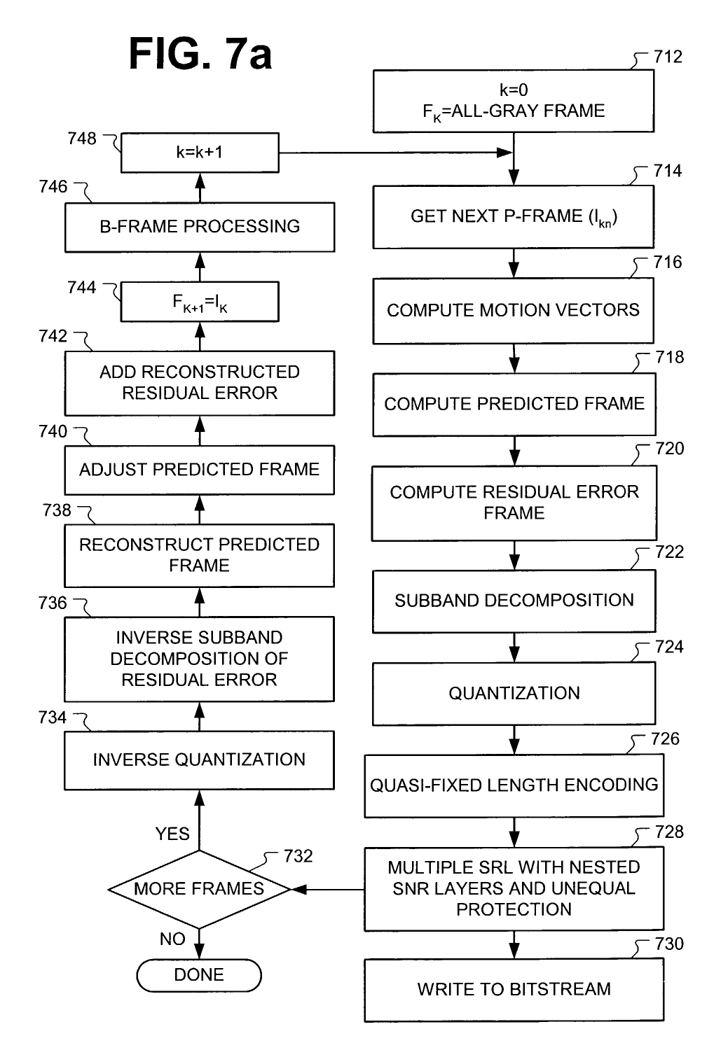

FIGS. 6a and 6b show a first example of video compression. The encoder is initialized with an all-gray frame (612). Thus the reference frame is an all-gray frame.

Referring to FIG. 6a, a video frame is accessed (614), and motion vectors are computed (616). A predicted frame (Î) is based on the reference frame and the computed motion vectors (618). The motion vectors are placed in a bitstream. The residual error frame is computed as R=I−α·Î (620). The residual error frame R is next encoded in a scalable manner: a wavelet transform of R (622); quantization of the coefficients of the error frame R (624); and subband-by-subband quasi-fixed length encoding (626). The motion vectors and the encoded residual error frame are packed into multiple spatial layers and nested SNR layers with unequal error protection (628). The multiple SRL layers are written to a bitstream (630).

If another video frame needs to be compressed (632), a new reference frame is generated for the next video frame. Referring to FIG. 6b, the new reference frame may be generated by reading the bitstream (650), performing inverse quantization (652) and applying an inverse transform (654) to yield a reconstructed residual error frame (R*). The motion vectors read from the bitstream and the previous reference frame are used to reconstruct the predicted frame (Î*) (656). The predicted frame is adjusted by the factor α (658). The reconstructed residual error frame (R*) is added to the adjusted predicted frame to yield a reconstructed frame (I*) (660). Thus I*=α·Î*+R*. The reconstructed frame (I*) is used as the new reference frame, and control is returned to step 614.

FIG. 6b also shows a method for reconstructing a frame (652-660). As the bitstream is being generated, it may be streamed to a decoder, which performs the frame reconstruction. To decode the first frame, the decoder may be initialized to an all-gray reference frame. Since the motion vectors and residual error frames are coded in a scalable manner, the decoder could extract smaller truncated versions from the full bitstream to reconstruct the residual error frame and the motion vectors at lower spatial resolution or lower quality. Whatever error in the reference frame is incurred due to the use of a lower quality and/or resolution reconstruction at the decoder, it has only a limited impact because the factor α causes the error to die down exponentially within a few frames.

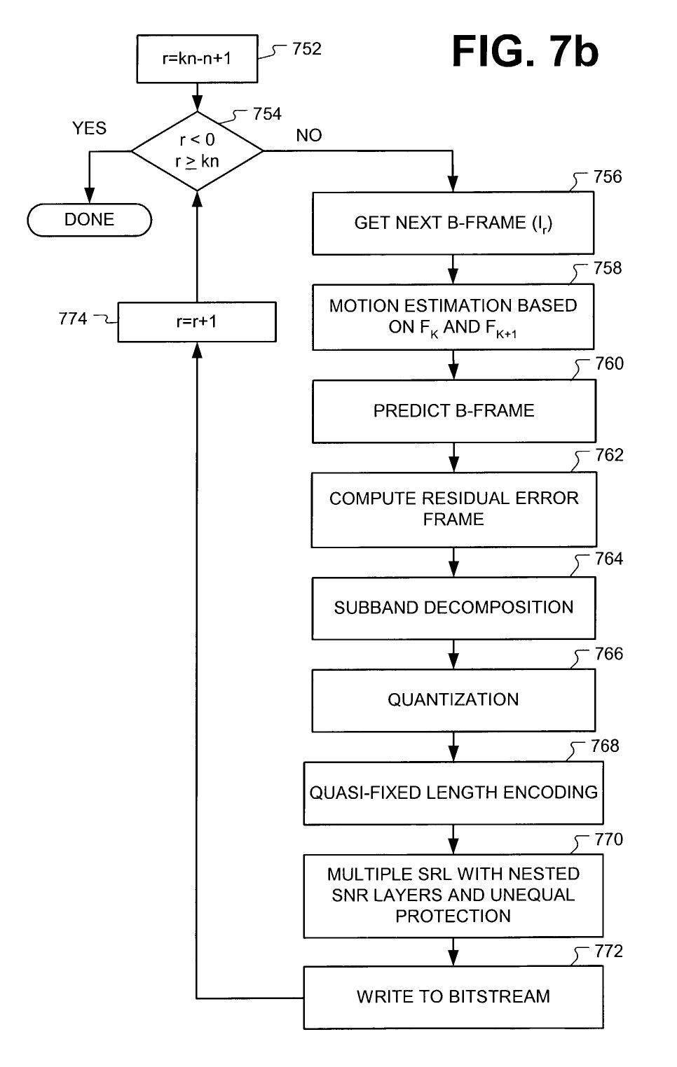

FIGS. 7a and 7b show a second example of video compression. In this second example, P-frames and B-frames are used. A B-frame may be bidirectionally predicted using the two nearest P-frames, one before and the other after the B-frame being coded.

Referring to FIG. 7a, the compression begins by initializing the reference frame Fₖ₌₀ as an all gray frame (712). A total of n−1 B-frames are inserted between two consecutive P-frames. For example, if n=4, then three B-frames are inserted in between two consecutive P-frames.

The next P-frame is accessed (714). The next P-frame is the kn^{th} frame in the video sequence, where kn is the product of the index n and the index k. If the total number of frames in the sequence is not at least kn+1, then the last frame is processed as a P-frame.

The P-frame is coded (716-728) and written to a bitstream (730). If another video frame is to be processed (732), the next reference frame is generated (734-744). After the next reference frame has been generated, B-frames are processed (746).

B-frame processing is illustrated in FIG. 7b. The B-frames use index r=kn−n+1 (752). If the B-frame index test (r<0 or r ≧kn) is true (754), then B-frame processing is ended. For the initial P-frame, k=0 and r=−3; therefore, no B-frames are predicted. On incrementing index k to k=1 (748 in FIG. 7a), the next P-frame 14 (I=4 since k=1 and n=4) is encoded. This time, r=1 and the next B-frame I₁ is processed (756-770) to produce multiple spatial resolution layers. The index r is incremented to r=2 (774) and passes the test (754), whereby B-frame I₂ is processed (756-770). Similarly, B-frame I₃ is processed (756-770). For r=4, however, the test is true (754), the B-frame processing stops, whereby the next P-frame is processed (FIG. 7a). The encoding order is I₀ I₄ I₁ I₂ I₃ I₈ I₅ I₆ I₇ I₁₂ . . . corresponding to frames P₀ P₁ B₁ B₂ B₃ P₂ B₄ B₅ B₆ P₃ . . . , while the temporal order would be P₀ B₁ B₂ B₃ P₁ B₄ B₅ B₆ P₃ . . . . The B-frames are not adjusted by the factor α because errors in them do not propagate to other frames.

From such a scalable bitstream for each frame, different decoders can receive different subsets producing lower than full resolution and/or quality, commensurate with their available bandwidths and display/processing capabilities. A low SNR decoder simply decodes a lower quality version of the B-frame. A low spatial resolution decoder may either use sub-pixel motion compensation on its lower resolution reference frame to obtain a lower resolution predicted frame, or it may truncate the precision of the motion vectors for a faster implementation. While the lower quality decoded frame would be different from the encoder's version of the decoded frame, and the lower resolution decoded frame would be different from a downsampled full-resolution decoded frame, the error introduced would typically be small in the current frame, and because it is a B-frame, errors do not propagate.

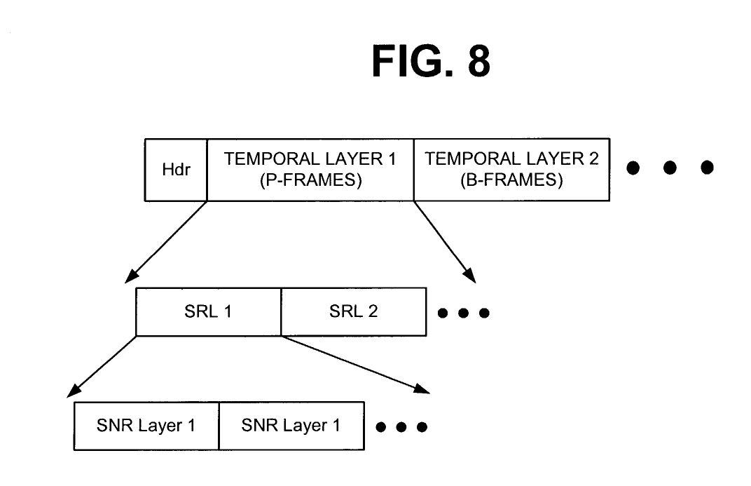

If all the data for the B-frames are separated from the data for the P-frames, temporal scalability is automatically obtained. In this case, temporal scalability constitutes the first level of scalability in the bitstream. As shown in FIG. 8, the first temporal layer would contain only the P-frame data, while the second layer would contain data for all the B-frames. Alternatively, the B-frame data can be further separated into multiple higher temporal layers. Each temporal layer contains nested Spatial Layers, which in turn contain nested SNR layers. Unequal error protection could be applied to all layers.

The encoding and decoding is not limited to P-frames and B-frames. Use could be made of Intra-frames, which are generated by coding schemes such as MPEG 1, 2, and 4, and H.261, H.263, H.263+, and H.263L. While the MPEG family of coding schemes use periodic I-frames (period typically 15) multiplexed with P- or B-frames, in the H.263 family (H.261, H.263, H.263+, H.263L), I-frames do not repeat periodically. The Intra-frames could be used as reference frames. They would allow the encoder and decoder to become synchronized.

The present invention is not limited to the specific embodiments described and illustrated above. Instead, the present invention is construed according to the claims that follow.

1. A method of compressing a current frame in a video sequence, the method comprising:
generating an estimate of the current frame;
adjusting the estimate by a factor α, where 0<α1; and
computing a residual error between the current frame and the adjusted estimate.

2. The method of claim 1, wherein the estimate is based on motion vectors between blocks in a previous frame and blocks from the adjusted estimate.

3. The method of claim 1, further comprising initializing the compression with an all-gray frame.

4. The method of claim 1, wherein the estimate is a P-frame.

5. The method of claim 1, wherein additional frames are estimated, some of the estimated frames being P-frames, others being B-frames, and wherein only the P-frames are adjusted by the factor α.

6. The method of claim 5, wherein some of the additional frames are I-frames, the I-frames used for reference.

7. The method of claim 1, wherein the factor α is within the range 0.6 to 0.8.

8. The method of claim 1, wherein the factor α is within a range such that the current frame is virtually independent of at least 8-10 previous frames in the sequence.

9. The method of claim 1, wherein the factor α is adjusted according to transmission reliability.

10. The method of claim 1, wherein the residual error is computed as R=I−αI_{E} where I_{E} represents the predicted frame, and I represents the current frame.

11. The method of claim 10, further comprising encoding the residual error in a scalable manner.

12. The method of claim 11, wherein the encoding of the residual error includes performing a subband decomposition of the residual error, the decomposition yielding different spatial resolution layers.

13. The method of claim 12, wherein the encoding further includes organizing each spatial resolution layer into multiple SNR layers.

14. The method of claim 13, wherein vector quantization is used to form the multiple SNR layers of each spatial resolution layer.

15. The method of claim 14, wherein the quantization is classified vector quantization such that different classes of vectors have different lengths.

16. The method of claim 14, wherein the quantization is multistage vector quantization.

17. The method of claim 16, wherein critical and non-critical information within each spatial resolution layer are protected unequally, and wherein critical information is contained with the first SNR layer of each spatial resolution layer, the critical information including vector quantizer classification indices.

18. The method of claim 13, wherein critical and non-critical information within each spatial resolution layer are protected unequally, and wherein critical information is contained with the first SNR layer of each spatial resolution layer.

19. The method of claim 18, wherein critical information is afforded greater protection than non-critical information within each spatial resolution layer.

20. Apparatus for compressing a sequence of video frames, the apparatus comprising a processor for generating an estimate of each frame in the sequence; adjusting each estimate by a factor α, where 0<α<1; and computing residual error frames for the adjusted estimates.

21. The apparatus of claim 20, wherein the processor is initialized with an all-gray reference frame.

22. The apparatus of claim 20, wherein the estimate is a P-frame.

23. The apparatus of claim 20, wherein additional frames are estimated, some of the estimated frames being P-frames, others being B-frames, and wherein only the P-frames are adjusted by the factor α.

24. The apparatus of claim 23, wherein some of the additional frames are I-frames, the I-frames used for reference.

25. The apparatus of claim 20, wherein the factor α is within the range 0.6 to 0.8.

26. The apparatus of claim 20, wherein the factor α is adjusted according to transmission reliability.

27. The apparatus of claim 20, wherein the processor encodes the residual error in a scalable manner.

28. The apparatus of claim 27, wherein the processor performs a subband decomposition of the residual error, the decomposition yielding different spatial resolution layers.

29. The apparatus of claim 28, wherein the processor organizes each spatial resolution layer into multiple SNR layers.

30. The apparatus of claim 29, wherein the processor uses vector quantization to form the multiple SNR layers of each spatial resolution layer.

31. The apparatus of claim 29, wherein critical and non-critical information within each spatial resolution layer are protected unequally; wherein critical information is contained with the first SNR layer of each spatial resolution layer; and wherein critical information is afforded greater protection than non-critical information.

32. An article for instructing a processor to compress a current frame in a video sequence, the article comprising a computer-readable medium programmed with instructions for instructing the processor to generate an estimate of the current frame; adjust the estimate by a factor α, where 0<α<1; and compute a residual error between the current frame and the adjusted estimate.

33. A method for reconstructing a sequence of video frames, the method comprising generating estimates of the video frames based on previous frames that have been decoded, adjusting the estimates by a factor α, where 0<α<1, decoding residual error frames, and adding the decoded residual error frames to the adjusted estimates.

34. The method of claim 33, wherein the factor α is within the range 0.6 to 0.8.

35. The method of claim 33, wherein inverse vector quantization is used to decode the residual error.

36. Apparatus for reconstructing a frame in a sequence of video frames, the apparatus comprising a processor for generating an estimate of the frame from at least one previously reconstructed frame, adjusting the estimate by a factor α, where 0<α<1, decoding residual error, and adding the decoded residual error to the adjusted estimate.

37. The apparatus of claim 36, wherein the processor is initialized with an all-gray reference frame.

38. The apparatus of claim 36, wherein the factor α is within the range 0.6 to 0.8.

39. The apparatus of claim 36, wherein inverse vector quantization is used to decode the residual error.

40. An article for instructing a processor to reconstruct a frame in a video sequence, the article comprising a computer-readable medium programmed with instructions for instructing the processor to generate an estimate of the frame from at least one previously reconstructed frame, adjusting the estimate by a factor α, where 0<α<1, decoding residual error, and adding the decoded residual error to the adjusted estimate.
